(19) United States
(12) Patent Application Publication
(10) Pub. No.: US 2010/0124364 A1
(43) Pub. Date: May 20, 2010

(54) ASSESSMENT OF BREAST DENSITY AND RELATED CANCER RISK

(76) Inventors: Zhimin HUO, Pittsford, NY (US); Zhiqiang LAO, Newtown, PA (US)

Correspondence Address: Carestream Health, Inc., 150 Verona Street, Rochester, NY, 14608, US

(21) Appl. No.: 12/471,675

(22) Filed: May 26, 2009

Related U.S. Application Data
(60) Provisional application No. 61/116,047, filed on Nov. 19, 2008.

(51) Int. Cl. G06K 9/00

(52) U.S. Cl. 382/128

(57) ABSTRACT

A method for assessing breast density executed at least in part by a computer system, identifies breast tissue from the electronic image data for at least one mammographic image, then performs an initial segmentation of fibroglandular tissue within the breast tissue according to at least one of gradient and uniformity data that is derived from the image data. The initial segmentation is refined using a pixel clustering process. A localized segmentation is obtained from the refined segmentation by generating and combining a density probability mapping and a homogeneity mapping from the image data. A percent density value for the at least one image is calculated and stored in a memory.

### CROSS REFERENCE TO RELATED APPLICATIONS

Reference is made to, and priority is claimed from, U.S. Ser. No. 61/116,047, filed as a provisional patent application on Nov. 19, 2008, entitled “Assessment Of Breast Density And Related Cancer Risk”, in the names of Zhimin Huo et al., and which is commonly assigned.

### FIELD OF THE INVENTION

The invention generally relates to image processing and analysis and computer-aided diagnosis (CAD) and more particularly relates to methods that assess and use data related to the density of breast tissue as a risk factor in breast cancer diagnosis.

### BACKGROUND OF THE INVENTION

In a number of studies, breast density has been found to be a factor for assessing cancer risk. Among factors that determine density is the relative proportion of dense to fatty tissues, sometimes expressed as mammographic percent density, or MPD. The average breast generally has about 50% fibroglandular tissue, a mixture of fibrous connective tissue and the glandular epithelial cells that line the ducts of the breast (the parenchyma), and 50% fat tissue. The radiological appearance of the breast varies between individuals, in part, because of variations in the relative amounts of fatty and fibroglandular tissue. Since fat has a lower effective atomic number than that of fibroglandular tissue, there is less x-ray attenuation in fatty tissue than in fibroglandular tissue. Fat appears dark (i.e., has a higher optical density) on a mammogram, while fibroglandular tissue appears light (i.e., exhibits a lower optical density). Regions of brightness associated with fibroglandular tissue are normally considered by diagnosticians to have increased “mammographic density”. It is known that mammographic imaging techniques are less successful with denser breast tissue than with predominantly fat tissue. Fibroglandular tissue in the breast tends to attenuate x-rays to a greater degree than does fat tissue, leading to increased difficulty in detection of cancer sites for denser breasts.

Assessment of breast density has been acknowledged to be useful for effective mammogram interpretation. As a guideline for classification, the American College of Radiology (ACR) Breast Imaging Reporting and Data System (BIRADS) has identified four major groupings for breast tissue density. Class I corresponds to breasts having high concentration of fat tissue. The Class II grouping indicates scattered fibroglandular densities. Class III indicates heterogeneously dense tissue. Class IV corresponds to extremely high breast density.

Women with increased mammographic parenchymal density can have four- to six times the risk over women with primarily fatty breasts. Some believe that increased density may indicate a relatively higher amount of tissue at risk for developing breast cancer. Since most breast cancers develop from the epithelial cells that line the ducts of the breast, having more of this tissue as reflected by increased mammographic density may indicate higher likelihood of developing breast cancer. In addition, some studies indicate that lesions in higher density areas are themselves more difficult to detect from the mammogram than are lesions in fatty regions, somewhat compounding the problem. Increase in density over time can also be an indicator of a disease condition.

Saha et al. in an article entitled “Breast tissue density quantification via digitized mammograms”, IEEE Transactions on Medical Imaging, vol. 20, no. 8, 2001) describes a scale-based fuzzy connectivity method to extract dense tissue regions from mammographic image; a comparison between segmentation in craniocaudal (CC) and mediolateral-oblique (MLO) mammographic views showed a strong correlation. Carri et al. in “A new method for quantitative analysis of mammographic density” (Medical Physics, 34(11), November 2007) propose a method of segmenting dense tissue from mammography using K-mean tissue clustering technique. Ferrari et al. in “Segmentation of the fibro-glandular disc in mammograms via Gaussian mixture modeling” (Med. Biol. Eng. Comput., vol. 42, pp. 378-387, 2004) used expectation maximization in combination with a minimum description length to provide the parameters for a mixture of four Gaussians. The statistical model was used to segment the fibroglandular disk, and a quantitative evaluation was provided. Selvan et al. in “Parameter estimation in stochastic mammogram model by heuristic optimization techniques” (IEEE Trans. Inf. Technol. Biomed., vol. 10, no. 4, pp. 685-695, 2006) used a heuristic optimization approach to estimate model parameters for a larger number of regions. Initial segmentation results were assessed by radiologists and showed improvement when compared to alternative approaches.

Still other approaches for distinguishing dense from fatty tissue using texture-based discrimination between tissue types according to spatial gray-level dependency matrices. Other researchers have developed segmentation techniques using a set of co-occurrence matrices and using the resulting density classification to compute the relative area of the density regions as the feature space.

While various methods may have achieved some level of success in segmenting and identifying areas of different density in the mammography image, however, there is acknowledged to be considerable room for improvement in density detection, display, and reporting. Moreover, although tissue density has been recognized as a significant factor for risk assessment, conventional mammography CAD systems have not utilized this information to help obtain improved results from diagnostic tools. Information relating to breast density has not been provided in any standard way, but must be obtained subjectively or must be calculated independently from the mammography image itself.

Applicants believe that, overall, obtaining and using tissue density information from the mammography image can help to manage patient care, to increase the effectiveness and value of imaging and image processing equipment, and to provide the diagnostician with a more uniform metric for describing and evaluating breast density.

### SUMMARY OF THE INVENTION

It is an object of the present invention to advance the art of computer-aided diagnosis for mammography and other tissue imaging. With this object in mind, the present invention provides a method for assessing breast density executed at least in part by a computer system, the method comprising: identifying breast tissue from the electronic image data for at least one mammographic image; performing an initial segmentation of fibroglandular tissue within the breast tissue according to at least one of gradient and uniformity data that is derived from the image data; generating a refined segmentation of the fibroglandular tissue within the breast tissue by refining the initial segmentation using a pixel clustering process; obtaining a localized segmentation from the refined segmentation by generating and combining a density probability mapping and a homogeneity mapping from the image data; and calculating a percent density value for the at least one image and storing the percent density value in a memory.

It is a feature of the present invention that it evaluates breast tissue density using both global and local image data in successive processing steps. This helps to avoid a condition in which the solution becomes trapped in a local minimum or maximum and helps to provide improved local and global results.

It is an advantage of the present invention that it is relatively insensitive to differences in image contrast or other quality characteristics or to differences due to the specific type of radiology system used for obtaining the image.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a logic flow diagram showing basic steps for density computation in one embodiment of the present invention.

FIGS. 2A, 2B, and 2C show the sequence of processing that follow the general flow given in FIG. 1, with accompanying views of the breast tissue to illustrate a number of the processing steps.

FIG. 3 is a graph that shows the use of a suitable threshold for separating dense from fatty tissue.

FIG. 4A is a view of initial segmentation of denser from fatty tissue in a mammographic image.

FIG. 4B is a view of segmentation to identify highly dense tissue in the image of FIG. 4A.

FIG. 4C is a histogram representative of the image data for FIGS. 4A and 4B.

FIG. 5 is a logic flow diagram that gives basic steps for feature-based segmentation that can be used to fine-tune the FCM-based segmentation of earlier processing.

FIG. 6 shows a binary-segmented image of breast tissue with a neighborhood defined in each of the fatty and denser tissue areas.

FIG. 7 is a block diagram that shows components used in a CAD system for mammography image data processing in one embodiment.

FIGS. 8A and 8B show an embodiment of an operator control panel that uses a display for threshold value entry and for showing results.

FIG. 9 shows a progression of images displayed with different density thresholds.

FIG. 10 shows a display having CC and MLO views for the same breast at different density thresholds.

FIG. 11 is a graph showing percent density plotted against a standard for multiple exams.

FIG. 12 is a graph showing percent density results from patient exams compared against mean values for a minimal-risk group.

### DETAILED DESCRIPTION OF THE INVENTION

The following is a detailed description of the preferred embodiments of the invention, reference being made to the drawings in which the same reference numerals identify the same elements of structure in each of the several figures.

Reference is also made to commonly assigned U.S. patent application Ser. No. 11/616,953 filed 28 Dec. 2006 and entitled “Method for Classifying Breast Tissue Density” by Luo et al.

For the detailed description that follows, the mammographic image is defined as f(X), where X denotes the pixel array and f(x) denotes the intensity value for pixel x in X.

In the context of the present disclosure, the term “dense tissue” is generally considered synonomous with fibroglandular tissue of the breast. Within the mammography image, this dense tissue is readily distinguishable from fatty tissue to those skilled in breast cancer diagnosis.

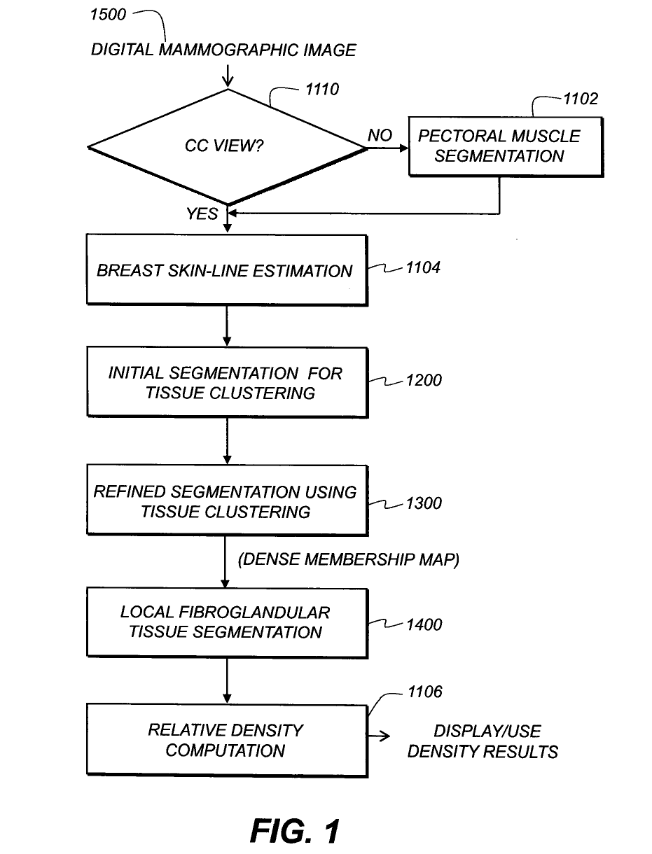

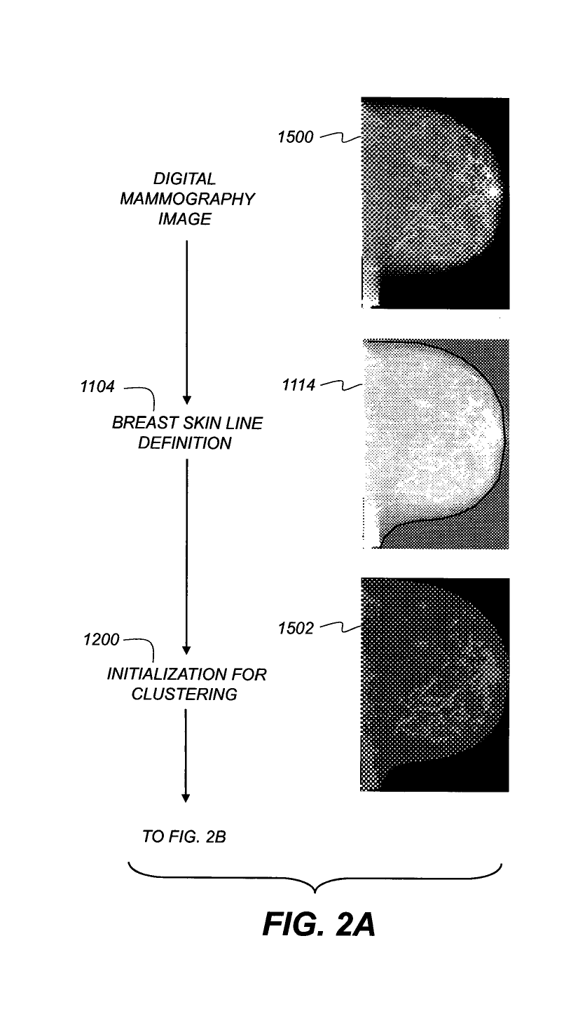

The logic flow diagram of FIG. 1 and graphical sequence of FIGS. 2A, 2B, and 2C show a basic sequence for obtaining density information from a digital mammographic image 1500. The image data can be from a scanned film x-ray or from a computed-radiography (CR) or digital radiography (DR) system. An initial test step 1110 checks for the type of image. A cranio-caudal (CC) view can be processed directly, a medio-lateral oblique MLO view, on the other hand, requires one additional segmentation step 1102 to exclude muscle tissue from the density analysis that follows. Further segmentation of the breast image is provided in a skin line estimation step 1104 that defines the contour of the breast tissue as shown in an image 1114.

Processing using the sequence shown in FIG. 1 progresses in a sequence that begins with a coarse initial global segmentation and proceeds with one or more steps of increasingly finer local segmentation to provide correspondingly more accurate quantification of breast density. An initial segmentation step 1200 provides initial membership assignment using a global feature-based clustering method. Feature-based clustering uses gradient and uniformity information in order to provide a level of segmentation that maximizes both intra-class uniformity and inter-class gradient. This initial tissue segmentation provides a relatively coarse estimation for identifying fatty and dense tissue in intensity space, as shown in a processed image 1502 (FIG. 2A). This estimation may have some inaccuracy, but yields interim results that can be used for defining initial membership and are used in subsequent pixel clustering steps.

Still referring to the process of FIG. 1, tissue clustering step 1300 then uses the initial segmentation results provided from initial segmentation step 1200 as a starting point for applying a more refined segmentation method to generate the dense membership map. In one embodiment, a binary fuzzy c-means (FCM) pixel clustering method is used to provide binary clustering results 1504 or, in an alternate form of presentation, 1506 (FIG. 2B). FCM pixel clustering algorithms are well known to those skilled in the image analysis arts. Pixel clustering techniques such as FCM and related methods give a probabilistic result for clustering that is based on factors including intensity (density, or gray level) of the image data.

Tissue clustering in step 1300 yields the dense membership map of binary clustering results 1504 or 1506 (FIG. 2B). In practice, FCM pixel clustering techniques assign each pixel a fatty probability and a dense probability, respectively, then apply a threshold, computed as described subsequently, that suitably classifies the pixel as either representing fatty or dense tissue. This method requires some preprocessing due to significant variation among different mammography systems and images. Where there are blur boundary pixels of a tissue region, this segmentation can be more challenging for generating the dense membership map shown in 1504 and 1506.

A local fibroglandular tissue segmentation step 1400 then performs further segmentation using features based on local variation and density spatial relationships and applying feature-based clustering. This generates a binary segmentation, shown overlaid against the original in an overlay image 1516 (FIG. 2C). A computation step 1106 then uses the results of segmentation step 1400 to obtain one or more values that quantify breast tissue density for the mammography image. This data is then stored in an electronic memory and can be displayed or used as input data for risk assessment or for other processing logic. Tissue segmentation step 1400 is described in more detail subsequently.

### Determining Density Area in Initial Segmentation Step 1200

The selection of an initial threshold that separates dense from fatty tissue is based on the observation that tissue within either the dense tissue region or the fatty tissue region is relatively homogeneous. The boundary between dense and fatty tissue contains most of the shape information, usually measured by the gradients of the points along the boundary. The desired threshold is one that can separate dense tissue from fatty tissue with a maximum gradient along the boundary and minimize the intensity variation within both tissue types. At the same time, this threshold value maximizes the variation between dense tissue and fatty tissue. Since it is difficult to calculate a single threshold t that both maximizes the gradient and maximizes inter-tissue variation, two interim thresholds t₁ and t₂, are first estimated, then used to calculate threshold t. The interim thresholds t₁ and t₂, and the calculated threshold t for this initial segmentation processing are defined using the following sequence in one embodiment:

1. Convert image data from 12-bit to 8-bit format. This generates a reduced-resolution grayscale image and simplifies subsequent computation.

2. Search the threshold t₁ that gives the maximum uniformity within each of the two regions separated by the threshold t₁.

3. Search the gray value t₂ that gives the maximum normalized gradient for pixels with a gray value of t₂.

4. Determine the resulting threshold t for initial membership assignment based on the values of t₁ and t₂. This can include finding the average of values t₁ and t₂, for example.

In step 2, uniformity measurement is used to select a threshold, t₁, that maximizes the computed homogeneity or uniformity within each tissue type. The uniformity of a feature (for example, its gray value) over a region is inversely proportional to the variance of the values of that feature, evaluated at every pixel belonging to that region. The lower this variance, the higher the uniformity.

With an image segmented into two regions, fatty and dense by the computed resulting threshold t, the uniformity measurement U(t) at the threshold t is defined as:

$$U ( t ) = 1 - \frac{{σ}_{1}^{2} + {σ}_{2}^{2}}{{Cont}_{1}} \qquad ( 1 )$$

where σᵢ is the standard deviation of pixel intensities belonging to a respective region rᵢ; Cont₁ is a positive normalization constant. Using this computation, the threshold t₁ that gives the highest uniformity is searched sequentially for each of the 8-bit gray levels, from lowest (L) to highest (H).

$${t}_{1} = {argmax}_{t ∈ [ L , H ]} U ( t ) \qquad ( 2 )$$

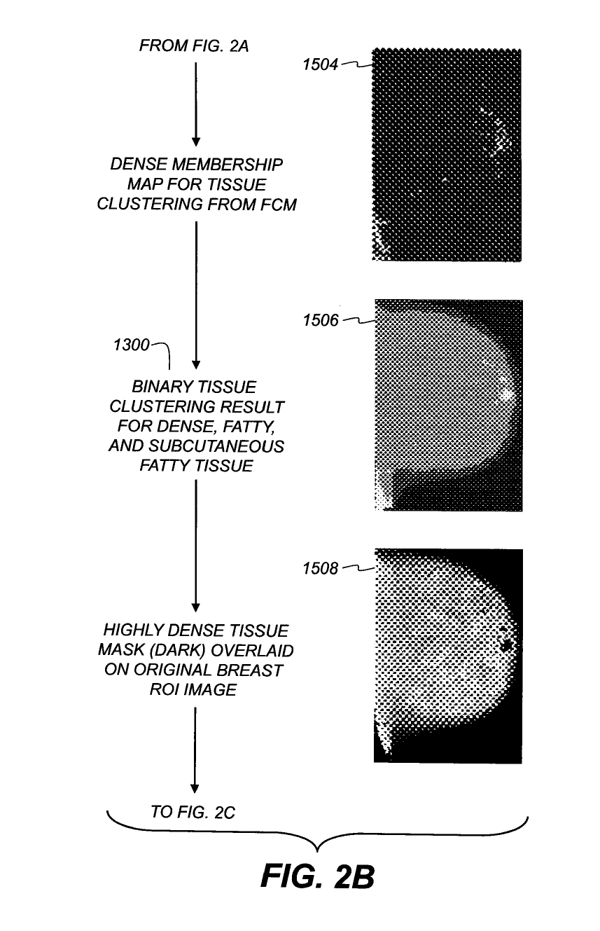

FIG. 3 shows the role of threshold t₁ in segmentation using this processing.

For step 3 as given earlier, gradient analysis then yields a type of shape measurement that can be used to select another threshold, t₂, relating the edges between two tissue types. A shape measurement, G(k), can be defined as a normalized gradient from all the pixels whose gray value is k. Threshold t₂ is then determined using equation (3) to search each gray level in sequence, from low to high.

$${t}_{2} = arg {max}_{k ∈ [ L , H ]} G ( k ) \qquad ( 3 )$$

In general, values t₁ obtained from (2) and t₂ obtained from (3) are not the same. It would be best to have an image segmented at an ideal threshold value t such that, after the threshold operation, the binary image has good uniformity as well as good shape information. To this end, the resulting threshold t for initial segmentation must satisfy the following relationship:

min(t₁, t₂)≦t≦max(t₁, t₂) (4)

In the sequence of FIG. 2A, obtaining this threshold yields processed image 1502.

### Tissue Clustering Step 1300

Tissue clustering step 1300 (FIG. 1) then uses the segmentation results provided from segmentation step 1200 as a starting point for applying a more refined segmentation method to generate the dense membership map. In one embodiment, a binary fuzzy c-means (FCM) pixel clustering method is used to provide binary clustering results 1504 and 1506. FCM pixel clustering algorithms are well known to those skilled in the image analysis arts.

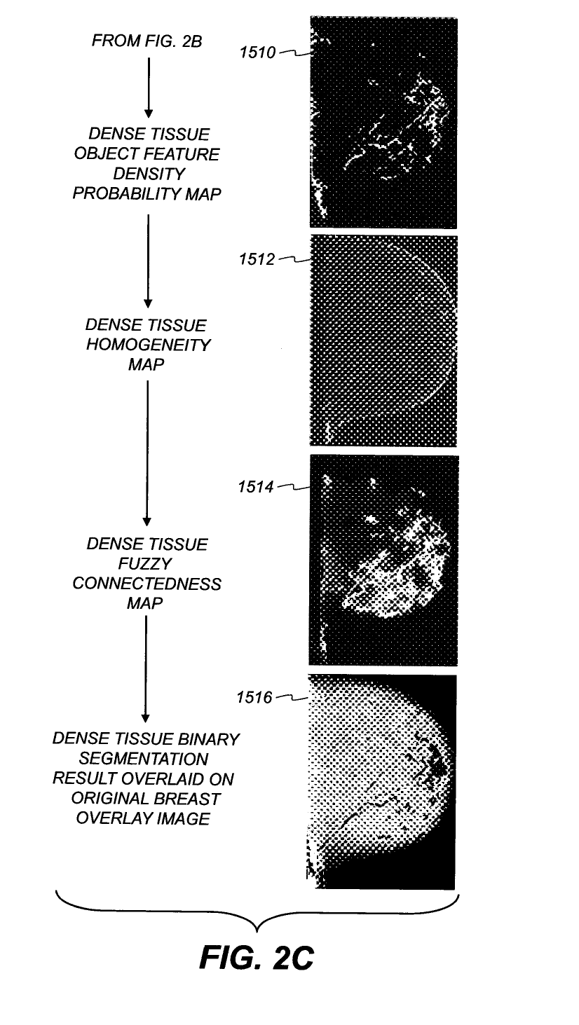

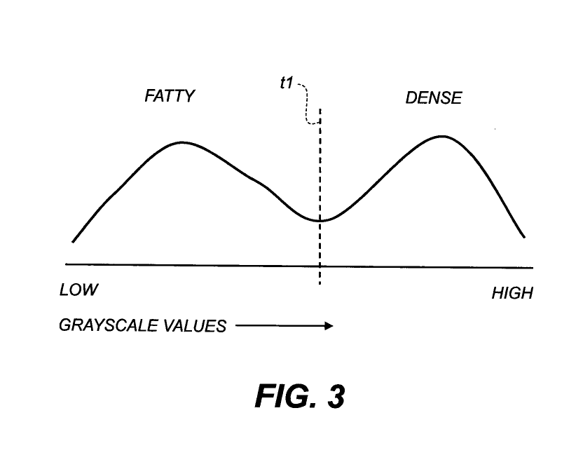

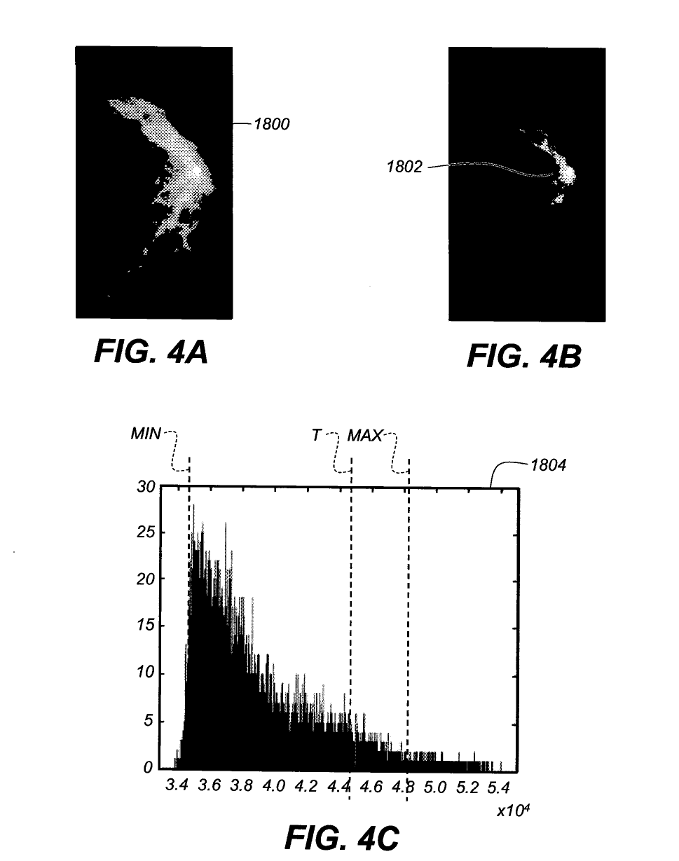

FIGS. 4A, 4B, and 4C show how a highly dense region is identified in one example embodiment. For the dense region determined using the FCM method in step 1300 (FIG. 1), it is possible to define the highly dense region, the dense membership mapping, in a number of ways. One way to determine the highly dense region is to obtain the smallest intensity value MIN by ignoring the lower 2.5% of intensity values in segmented dense tissue. The set of pixels having intensity not less than MIN+0.75(MAX−MIN) is then defined as a highly dense region. This is similar to the method shown with reference to FIGS. 4A-4C. The mean m_{ψ} and the standard deviation σ_{ψ} of a distribution of intensity values for the highly dense region are then calculated.

Referring to FIG. 4A, there is shown a dense tissue region 1800 that is obtained in initial segmentation step 1200. FIG. 4B shows a dense tissue seeding region 1802, a highly dense region that results from processing using a histogram of density values. FIG. 4C shows an exemplary histogram 1804 for the images in FIGS. 4A and 4B. FIG. 4A represents the full range of density values above a given threshold, considering the full range of the histogram in FIG. 4C. The high-density seeding region of FIG. 4B serves for the density map representing fibroglandular tissue in subsequent steps.

To obtain the highly dense region, a threshold value is obtained by first eliminating the upper and lower 5% of values from histogram 1804; these are regions of the data that typically have high levels of noise content. This sets new MAX and MIN values at each end of the histogram. The value that is used for a threshold T is then computed as follows:

T=(MIN+0.75(MAX−MIN)

Dashed lines in FIG. 4C indicate exemplary MAX, MIN, and threshold T values using this computation. This processing generates image 1504 in the example sequence of FIGS. 2A-2C.

### Improved Local Segmentation

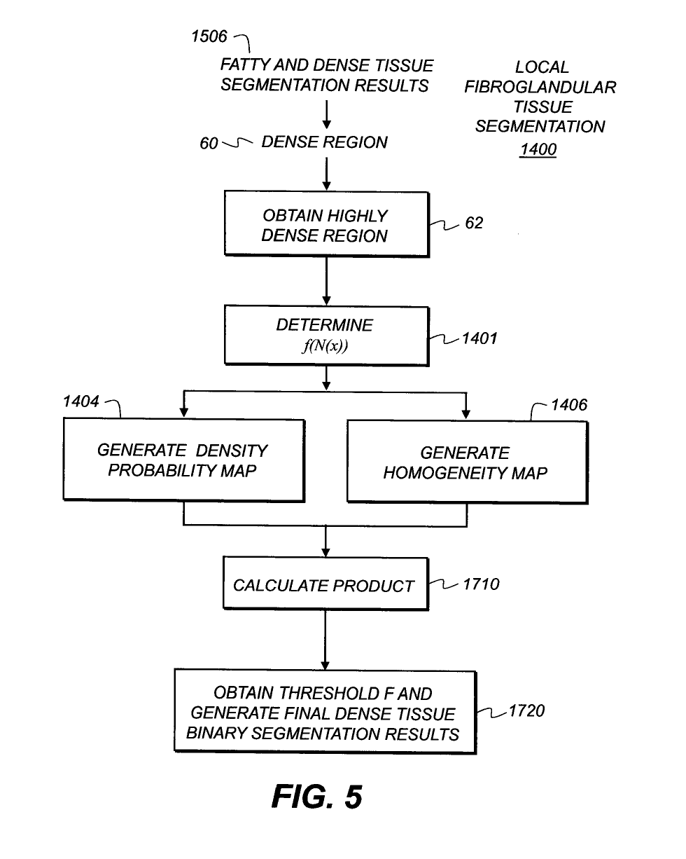

Following tissue clustering step 1300 in the sequence of FIG. 1, a more localized segmentation step 1400 provides further fine-tuning using a feature-based clustering technique that can be characterized as being more local or neighborhood-based than the more global initial segmentation in steps 1200 and 1300. This approach helps to compensate somewhat for perceptual differences between computerized and human observers. FIG. 5 shows basic sub-steps for localized segmentation step 1400 in one embodiment.

As shown in the block diagram of FIG. 5, segmentation step 1400 processing begins with binary clustering results 1504 or 1506 (FIG. 2B). From these, a dense region 60 (corresponding to dense tissue region 1800 in FIG. 4A) is identified. A highly dense region 62 (corresponding to seeding region 1802 in FIG. 4B) is then identified within the dense tissue data and is used in a super-pixel size determination step 1401 and for determining Gaussian-weighted intensity (f(N(x)) Super-Pixel Size and f(N(x)) Determination

In super-pixel size determination step 1401 of FIG. 5, a Gaussian-weighted intensity value f(N(x)) is obtained for pixel x. The Gaussian-weighted intensity value f(N(x)) is the sum of Gaussian-weighted intensities of all pixels belonging to N(x), and can be computed as:

$$f ( N ( x ) ) = \frac{{\sum }_{{x}^{′} ∈ N ( x )} f ( {x}^{′} ) {G}_{0 , r ( N ( x ) )} ( ‖ {x}^{′} - x ‖ )}{{\sum }_{{x}^{′} ∈ N ( x )} {G}_{0 , r ( N ( x ) )} ( ‖ {x}^{′} - x ‖ )} \qquad ( 5 )$$

wherein:
G_{m,σ} Un-normalized Gaussian with mean m and standard deviation σ.
∥x′-x∥ Euclidean distance between x and x′.

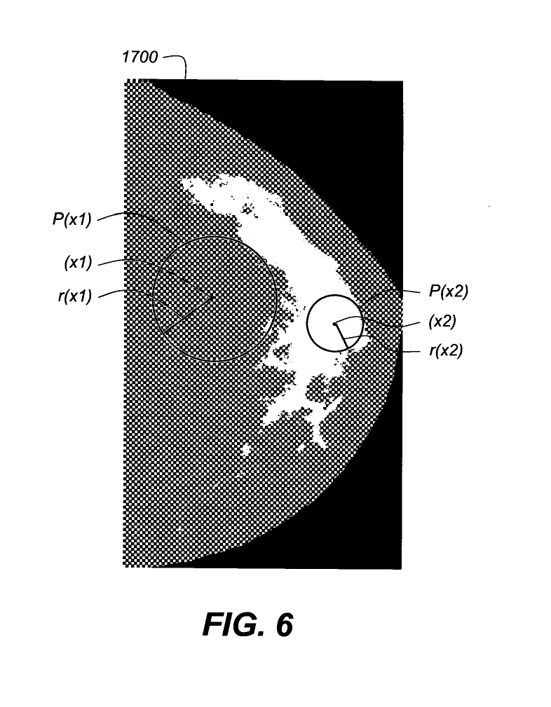

Using this sequence, a super-pixel neighborhood, N, is defined for each pixel x∈X. The sequence for executing super-pixel size determination step 1401 to determine the radius of a circular neighborhood r(x), is as follows, using the example segmented image 1700 of FIG. 6. In FIG. 6, fatty regions appear gray, dense regions appear light.

For each pixel x, a super-pixel is determined as follows:
1) Determine the largest circle that is centered at the pixel x within its respective region, whether fatty or dense.
2) Determine the radius r(x) of the circle from step 1 or generate a radius (distance) map in which the brightness of each pixel corresponds to this radius distance within its respective region.

Each super-pixel neighborhood N(x) is thus defined as a circular neighborhood with a radius of r(x). In the example of FIG. 6, two super-pixels P(x1) and P(x2) are shown as circular neighborhoods, centered at pixels x₁ and x₂ respectively. Pixel x₁ lies within the fatty region and its circular neighborhood has a radius r(x₁). Pixel x₂ lies within the highly dense region and its circular neighborhood has a radius r(x₂). The super-pixel for x₂ is the neighborhood N2 within the radius of r(x₂). The super-pixel for x₁ is the neighborhood N1 within the radius of r(x₁).

### Density Probability Map Generation

Referring again to the localized segmentation sequence of FIG. 5, a density probability map generation step 1404 then combines the sums of Gaussian-weighted intensities of all pixels belonging to N(x) to form the density probability map for all tissue pixels. An exemplary feature map 1510 is shown in FIG. 2C. This map indicates the relative likelihood that any particular pixel will be within the dense region. The density probability map can be generated using the following sequence:
1) Assign a probability value of 1 to all the pixels within the highly dense region (image 1508 in FIG. 2B).
2) Determine the mean m_{φ} and standard deviation (STD) σ_{φ} of the highly dense region.
m_{φ} and σ_{φ} the mean and standard deviation of pixel intensities in the highly dense tissue region.
   3) Calculate a weighted density probability W_{φ}(x) for each pixel outside the highly dense region as illustrated by the following equation

$${W}_{φ} ( x ) = \{ \begin{matrix}{G}_{{m}_{φ} , {σ}_{φ}} ( f ( N ( x ) ) ) , & if f ( N ( x ) ) < {m}_{φ} \\ 1 , & otherwise\end{matrix} \qquad ( 6 )$$

### Homogeneity Map Generation

The next step in the sequence of FIG. 5 uses the super-pixel N(x) circular neighborhood arrangement just described in order to form a homogeneity map that quantifies the difference between two neighboring regions of the image. An exemplary feature map 1512 is shown in FIG. 2C. A homogeneity map generation step 1406 has the following sequence in one embodiment:

For any two neighboring pixels x₁ and x₂ (these could, alternately, be nearby pixels, separated by a distance of d) with super-pixels N(x₁) and N(x₂):
1) Determine the minimum radius min {r(N(x₁)),r(N(x₂))} of their respective circular or “super” neighborhoods.
2) Define two circles, each centered at one of the two points x₁ and x₂, each with a radius of min {r(N(x₁)),r(N(x₂))} obtained in step 1).
3) Calculate the intensity difference of corresponding points in the two circular neighborhoods, weighted by a Gaussian distribution as illustrated subsequently.

A component ψ measures homogeneity and indicates the level of intensity difference between the circular neighborhoods N(x₁) and N(x₂) by computing intensity differences of corresponding pixels between N(x₁) and N(x₂). Because the original radii of N(x₁) and N(x₂) may be different, the radii for both N′(x₁) and N′(x₂) are set equal to min {r(N(x₁)),r(N(x₂))}. Considering any two pixels x₁′∈N′(x₁) and x₂′∈N′(x₂) such that they represent the corresponding points within N′(x₁) and N′(x₂), that is, x_{1,i}′ and x_{2,i}′, the difference δ in intensity between the two corresponding points is computed:

δ(x′_{1,i}, x′_{2,i})=|f(x′_{1,i})−f(x′_{2,i})| (7)

Then the weighted difference D between the two circular neighborhoods N′(x₁) and N′(x₂) is:

$$D ( {N}^{′} ( {x}_{1} ) , {N}^{′} ( {x}_{2} ) ) = {\sum }_{i} [ 1 - {G}_{0 , {m}_{ψ} + 3 {σ}_{ψ}} ( δ ( {x}_{1 , i}^{′} , {x}_{2 , i}^{′} ) ) ] \cdot {G}_{0 , min \{ \begin{matrix}r ( N ( {x}_{1} ) ) , \\ r ( N ( {x}_{2} ) )\end{matrix} \}} ( ‖ {x}_{1} - {x}_{1 , i}^{′} ‖ ) \qquad ( 8 )$$

where
m_{ψ} and σ_{ψ} Expected mean and standard deviation of intensity differences between all pairs of adjacent pixels within initial dense tissue region, respectively.
G is the Gaussian function.

The feature map can be computed as:

μₖ(x)=1/C\sqrt{D_{ψ}(x)W_{φ}(x)} (9)

wherein D_{ψ} gives the weighted difference for pixels in the initial dense tissue region. The feature map can be further normalized using 1/C.

Referring back to FIG. 5, a calculation step 1710 then multiplies the density probability map generated in step 1404 with the homogeneity map results generated in step 1406. This generates a feature map 1514 shown in FIG. 2C. In a final step 1720, a suitable threshold value F can be calculated and final dense tissue segmentation results can be displayed, such as shown in an overlay image 1516, for example. Color can be used to highlight highly dense fibroglandular tissue on the display.

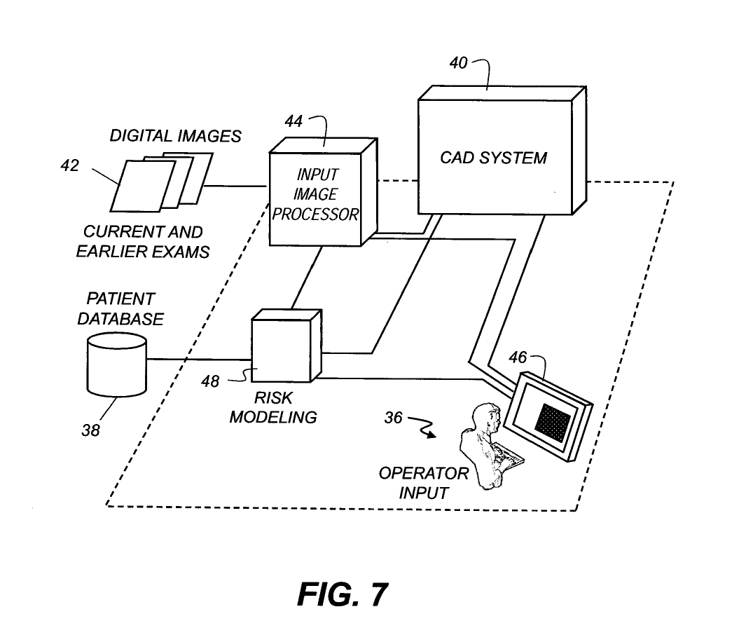

Referring to FIG. 7, embodiments of the present invention execute on a CAD (Computer-Aided Diagnosis) system 40 that cooperates with an input image processor 44 and provides the control logic processing, data storage, input/output, and display 46 components that support automated diagnosis. Digital images 42 from current and earlier exams, generated using either scanned film or computed radiography (CR) or digital radiography (DR) systems, are provided to input image processor 44 that provides a number of the image processing functions described earlier and transmits processed image data to other CAD system 40 components and to memory or storage circuitry. Extracted data from input image processor 44 goes to a risk modeling processor 48 or subsystem in communication with the input image processor 44 that provides further processing and analysis based on stored modeling logic instructions. A patient database 38 can store other relevant information such as age, family history and patient history, accessible for risk modeling. A control console 36 is provided for viewer input, working in conjunction with display 46. It can be appreciated that the overall arrangement of FIG. 7 admits any of a number of alternative embodiments, with various possible types of computers or other control logic processors, including networked computers and processors, with memory and data storage components incorporated within or otherwise associated with each of the processors shown, such as by network connections. Stored program instructions and data enable the execution of the various processes and algorithms used by CAD system 40 and related control logic processors.

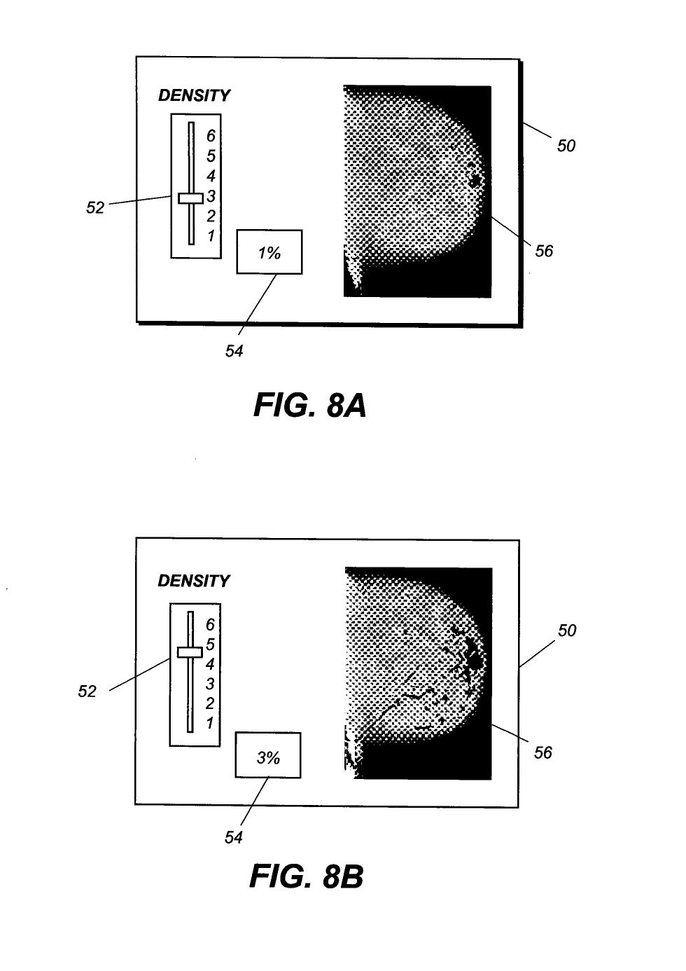

Embodiments of the present invention not only provide the automated calculations described, but also provide a viewer with the capability to enter and adjust threshold values used in this processing or select the best density segmentation from a set of pre-calculated density values. FIGS. 8A and 8B show a graphical user interface 50 used for display of mammography output. With reference to FIG. 7, the user interface capabilities shown could be available on control console 36 or some other related processor. A control 52 allows the viewer to make an adjustable threshold setting that is used by control logic of the CAD system for processing and displaying results. Control 52 is shown as a screen icon of the slide-bar type, but could be any of a number of types of on-screen graphical or textual elements that can be manipulated by the viewer or other operator. In one embodiment, control 52 is a touchscreen control. Alternately, an element adjustable by an operator using a mouse or other manually operated pointer or a typed keyboard command could be used. An image display 56 and an alphabetic display 54 are provided in order to show the results of processing using the viewer-entered threshold.

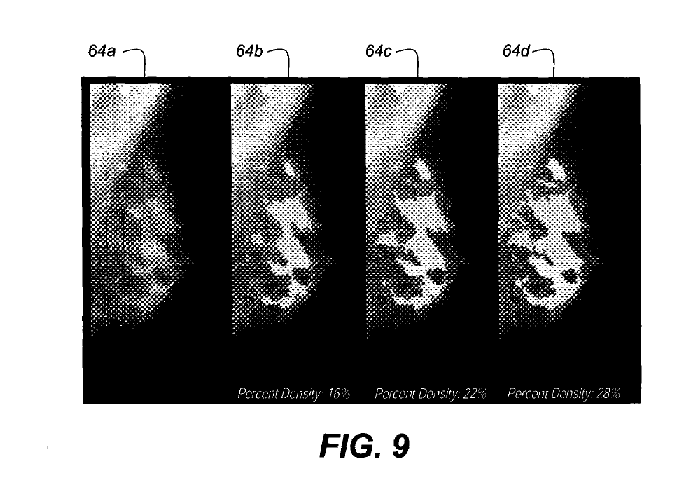

FIG. 9 shows a progression of images 64a, 64b, 64c, and 64d presented with different density thresholds determined by an automated segmentation algorithm. Viewers are allowed to manually select the image that best estimates their density assessment. The percent density is computed at each threshold and reported along with the images. This helps to provide an objective quantification of the relative amount of tissue that is considered to be dense for a given threshold setting. Providing this value can help the diagnostician to establish a basis for standardization when describing breast density for a particular patient.

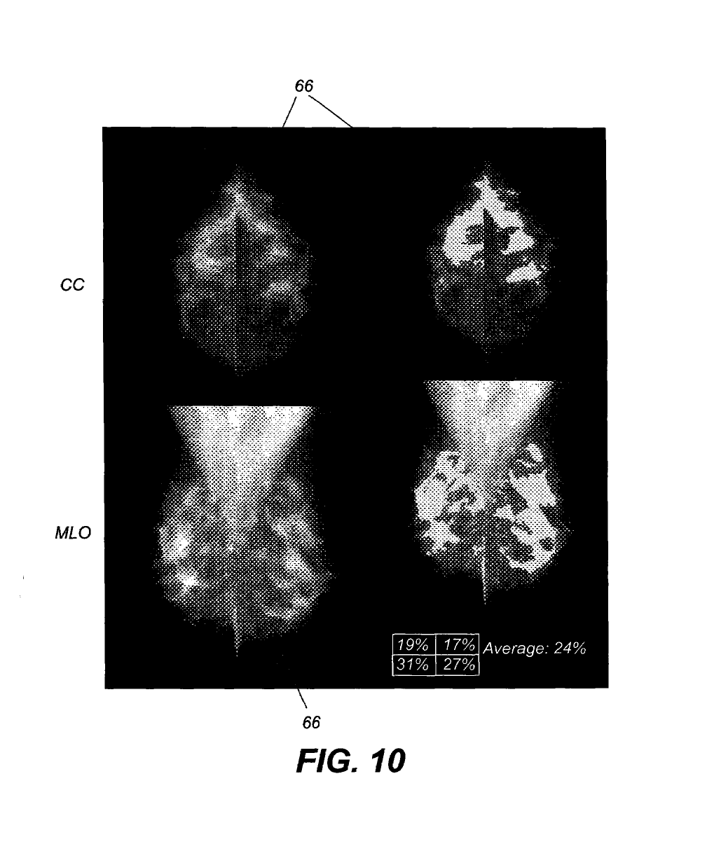

FIG. 10 shows an arrangement of all 4 views 66 from one patient as displayed following breast density processing. CC images are in the top portion; MLO images in the bottom portion. These show the results at the thresholds either determined by computer processing or selected by the viewer from the user interface display of FIG. 9.

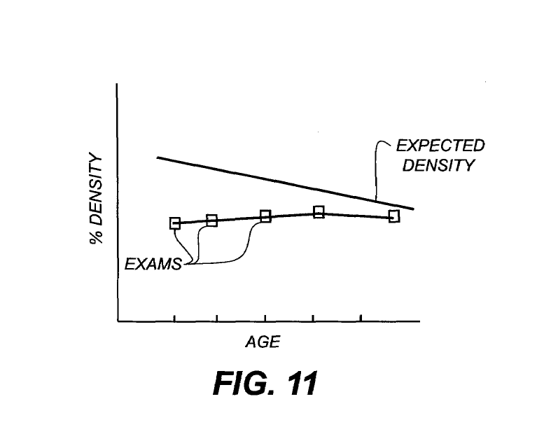

As was described earlier with reference to FIG. 7, the threshold value can be input to an automated risk model that executes in conjunction with CAD system control logic and provides recommendations or assessment based on its image processing. For example, the graph of FIG. 11 shows a plot of percent density from a number of previous exams for a patient, compared against an expected value from a representative population in the same age group. The expected value can be adjusted for an ethnic group of interest or other risk factors. In general, density is expected to decrease with age as shown.

### Percent Density Calculation

In one embodiment, the percent density calculation uses the segmented dense area from step 1516 (FIG. 2C) divided by the breast area from step 1114 (FIG. 2A). Percent density can be calculated for each image, for each breast, or for each patient. The average of percent density from one exam, usually consisting of 4 standard views, can be used as the breast density for the patient. In FIG. 10, the percent density for each view in the quadrants and the average of the 4 views for the patient is reported and stored in memory. Further, percent density can be calculated for mammograms acquired over a period of time, such as more than one year earlier, for example. A graph as shown in FIG. 11, for example, can be displayed to show a trend for breast density for a particular patient and may provide a comparison curve, such as a graph showing risk for a particular patient as it relates to a broader population of patients. In addition, various risk factors can also be accounted for in the displayed data.

### Risk Modeling

Breast cancer risk (5-year, 10-year or lifetime risk) can be estimated using existing clinical risk models such the Gail model, familiar to those skilled in mammography risk assessment, based on age, family history, patient history and breast density. The calculated risk can be reported along with other information in the breast density report.

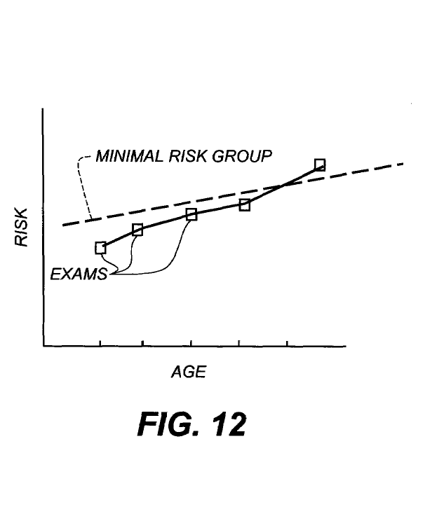

Similar to breast density as shown in FIG. 11, the estimated risks can be plotted for display against time and/or patient age, such as in comparison with a baseline population who are considered to have no risk factor in the same age group. The example graph of FIG. 12 shows a plot of relative risk results from patient exams compared against an indicator of mean values for a minimal-risk group. Graphs such as those shown in these examples help to give a visual comparison of change in density or risk over time for an individual and provide a visual comparison against a group of interest.

Embodiments of the present invention make it possible to provide a heightened level of automated risk management for patients having a density value above a threshold or having other characteristics that make it advisable to monitor density more closely. Embodiments of the present invention can be used for mammography images from any type of radiographic equipment, whether from scanned film, CR, or DR modalities. Because the method of the present invention is insensitive to absolute density differences, it can be readily used for patients having mammograms taken on film and taken using CR and DR media.

The invention has been described in detail with particular reference to a presently preferred embodiment, but it will be understood that variations and modifications can be effected within the spirit and scope of the invention. While the methods of the present invention have been described with reference to mammography, these can also be applied for other types of tissue imaging where it is useful to distinguish and otherwise characterize tissue according to its relative density.

The presently disclosed embodiments are therefore considered in all respects to be illustrative and not restrictive. The scope of the invention is indicated by the appended claims, and all changes that come within the meaning and range of equivalents thereof are intended to be embraced therein.

### Parts List

36. Control console
38. Patient database
40. CAD system
42. Digitized image
44. Input image processor
46. Display
48. Risk modeling processor
50. Graphical user interface
52. Control
54. Display
56. Display
60. Dense region
62. Highly dense region
64a, 64b, 64c, 64d. Image
66. Image
1102. Segmentation step
1104. Skin line estimation step
1106. Computation step
1110. Test step
1114. Image
1200. Segmentation step
1300. Tissue clustering step
1400. Localized segmentation step
1401. Super-pixel size determination step
1404. Density probability map generation step
1406. Homogeneity map generation step
1500. Digitized mammography image
1502. Processed image
1504, 1506. Binary clustering results
1508. Overlaid image
1510. Density probability map
1512. Homogeneity map
1514. Feature map
1516. Overlay image
1700. Image
1710. Calculation step
1720. Final step
1800. Dense tissue region
1802. Seeding region
1804. Histogram

What is claimed is:

1. A method for assessing breast density, executed at least in part by a computer system, the method comprising:
identifying breast tissue from the electronic image data for at least one mammographic image;
performing an initial segmentation of fibroglandular tissue within the breast tissue according to at least one of gradient and uniformity data that is derived from the image data;
generating a refined segmentation of the fibroglandular tissue within the breast tissue by refining the initial segmentation using a pixel clustering process;
obtaining a localized segmentation from the refined segmentation by generating and combining a density probability mapping and a homogeneity mapping from the image data; and
calculating a percent density value for the at least one image and storing the percent density value in a memory.

2. The method of claim 1 further comprising displaying the at least one image with detected fibroglandular tissue highlighted in a color.

3. The method of claim 1 wherein generating the refined segmentation comprises applying fuzzy c-means clustering.

4. The method of claim 1 wherein performing the initial segmentation comprises:
generating a reduced-resolution grayscale image;
identifying a first threshold in the reduced-resolution grayscale image according to a computed uniformity;
identifying a second threshold in the reduced-resolution grayscale image according to a computed gradient; and
calculating and applying a third threshold that lies between the first and second thresholds.

5. The method of claim 1 further comprising obtaining a threshold value entered by a viewer for conditioning the refined segmentation processing.

6. The method of claim 5 wherein obtaining the threshold value comprises obtaining a value from an on-screen control that is manipulated by the viewer.

7. The method of claim 1 further comprising displaying a plurality of calculated percent density values for a patient, arranged according to patient age.

8. The method of claim 1 further comprising graphically displaying one or more calculated percent density values for a patient, along with an indicator of relative risk for one or more of the displayed values.

9. The method of claim 1 further comprising providing a binary segmentation and calculated percent density value to a risk modeling program.

10. The method of claim 1 wherein obtaining a localized segmentation further comprises:
generating a weighted density probability for one or more pixels;
generating a homogeneity mapping for the one or more pixels;
generating a feature map as a product of the weighted density probability and homogeneity mapping; and
applying a threshold to the feature map to segment dense from the fatty tissue.

11. The method of claim 10 wherein generating the weighted density probability comprises:
identifying a highly dense region in the initial segmentation and estimating one or more intensity distribution statistics within the identified highly dense region;
assigning a probability of 1 to each pixel in the highly dense region; and
calculating a probability value for each pixel outside the highly dense region by calculating a Gaussian weighted intensity value for the pixel.

12. The method of claim 10 wherein generating a homogeneity mapping comprises calculating Gaussian weighted intensity differences over equal-sized areas surrounding two nearby pixels.

13. A diagnostic system for mammography comprising:
an input image processor that is responsive to stored instructions for obtaining a digital mammography image;
a computer-aided diagnostic system that is responsive to stored instructions for performing an initial segmentation of fibroglandular tissue according to at least one of gradient and uniformity data derived from the image, for refining the initial segmentation according to pixel clustering, for processing the refined segmentation according to computed density probability and homogeneity mapping, and for calculating a percent density value;
a memory operatively associated with the input image processor and storing the computed percent density value;
a risk modeling processor in communication with the computer-aided diagnostic system for obtaining at least the computed percent density value; and
a display operatively connected with the computer-aided diagnostic system and risk modeling processor for displaying at least the computed percent density value.
